(19) United States
(12) Patent Application Publication
(10) Pub. No.: US 2025/0350588 A1
(43) Pub. Date: Nov. 13, 2025

(54) EVENT-BASED AUTHENTICATION AND AUTHORISATION SYSTEM AND A METHOD THEREOF

(71) Applicant: AMIT KUMAR GAUTAM, PUNE (IN)

(72) Inventor: AMIT KUMAR GAUTAM, PUNE (IN)

(73) Assignee: ABLUVA PRIVATE LIMITED, PUNE (IN)

(21) Appl. No.: 19/200,701

(22) Filed: May 7, 2025

Related U.S. Application Data
(60) Provisional application No. 63/645,172, filed on May 10, 2024.

(51) Int. Cl. H04L 9/40

(52) U.S. Cl. CPC H04L 63/08

(57) ABSTRACT

An event-based authentication and adaptive authorisation system and a related method has been described in the present disclosure. The system enables continuous monitoring of user behaviours, contextual events, and security threats and dynamically adjusts access control policies and permissions in real-time. Authentication is derived from a combination of predefined and contextually learned user actions, enabling password-less hybrid authentication mechanisms. The system continuously assesses risk factors, anomalous behaviours, and evolving security conditions to refine access permissions. The system adapts to changing threat landscape and changing user behaviour. As a result, enhanced security, flexibility, and operational efficiency is achieved by the robust and responsive system that is becoming essential for organizations in today's environment of rapidly evolving cyber threats.

### FIELD OF THE INVENTION

The present disclosure relates to authentication and authorisation systems. More particularly, the present disclosure relates to a system and a method for dynamic authentication and authorisation in response to internal or external events and taking into consideration changing context.

### BACKGROUND

In recent times, protection of digital assets and sensitive information is of utmost importance. For information security and access management, authorisation and authentication systems play a pivotal role in safeguarding the digital resources and sensitive information. The authorisation and authentication systems are intended to ensure that only authorized and authenticated entities have access to the sensitive resources.

Conventional methods exist to control and restrict access to information and resources within an organization. A few conventional methods related to information security and access management include Role-Based Access Control (RBAC) and Attribute-Based Access Control (ABAC).

RBAC refers to an authorization system where access permissions are assigned based on the roles that users have within an organization. The permissions are associated with roles instead of assigning permissions directly to the users. The roles may refer to a set of permissions provided to the users which are related to specific responsibilities. The users are assigned the roles, and consequently, the permissions associated with the assigned roles. The access is thus based on responsibilities of the users

ABAC refers to an authorisation system where a wide range of attributes or characteristics are considered to determine access to information and resources. Multiple types of attributes may be considered, such as, user attributes, resource attributes, environmental attributes, etc. User attributes may include roles, departments, location, designation, etc. Resource attributes may include type and sensitivity of resources to be accessed. Further, environmental attributes may include time, network type, device type, etc. The attributes are considered along with defined policies in order to determine whether access is to be granted to users

The conventional methods for access control are static and rigid, in that, the conventional methods do not efficiently adapt to real-time changes such as security breaches, user behavioural changes, modifications in the infrastructure, etc. A robust security environment is thus difficult to maintain using the existing methods and techniques.

For instance, current RBAC and ABAC systems rely on static, predefined rules that lack the agility to adapt to real-time changes in the environment. This rigidity introduces potential security gaps and operational hindrances as it becomes difficult to respond to evolving conditions, thereby leading to increased risk of security gaps and hindered operations.

Further, predefined rules may be manually updated to respond to the evolving conditions. However, manual updating of rules is not only error-prone but can also result in delays, potentially increasing the risk of security breaches. The overall reliability of the authorisation system can thus be compromised.

Moreover, existing systems lack the ability to consider contextual factors such as time, location, or device during access decisions. This limitation may lead to over-authorization or under-authorization, as access control decisions may not adequately reflect the requirements of dynamic scenarios.

Moreover, existing authentication systems also suffer from various drawbacks. Knowledge-based authentication is widely used. Knowledge-based authentication includes passwords and security questions, however, such authentication methods are inherently insecure. For instance, passwords are vulnerable to phishing, brute-force attacks, and poor user practices like reuse or weak choices while security questions often rely on information that can be easily guessed or publicly discovered.

Another example of authentication techniques include possession-based methods by providing temporary codes for authentication. These can include, for instance, one-time passwords (OTPs) and hardware/software tokens. However, such temporary codes depend on external channels or devices that can be compromised, lost, or add operational complexity.

Biometric authentication is yet another example of authentication technique that leverages unique physical traits like fingerprints or facial recognition to verify identity. While convenient, biometric authentication requires specialized hardware and raises serious concerns, as compromised biometric data cannot be changed or revoked like traditional credentials.

Thus, existing authorisation and authentication methods and systems encounter challenges in adapting to changing environments. Therefore, there is a pressing need for an enhanced dynamic authorisation and authentication system that seamlessly adapts to evolving conditions, minimizes manual intervention, and considers a comprehensive set of contextual factors for precise and dynamic access control.

Therefore, in view of the above-mentioned problems, it is desirable to provide a system and a method for event-based dynamic authorisation and authentication.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an environment comprising a system for monitoring events, calibrating policies, and taking necessary actions to shift to the safe state, in accordance with an embodiment of the present disclosure;

FIG. 2A illustrates a block diagram of the system for monitoring events, calibrating policies, and taking necessary actions to shift to the safe state, in accordance with an embodiment of the present disclosure;

FIG. 2B illustrates a block diagram of a set of modules associated with the system for monitoring events, in accordance with an embodiment of the present disclosure;

FIG. 3 illustrates a process flow depicting operations among a set of modules of the system, in accordance with an embodiment of the present disclosure;

FIG. 4 illustrates a process flow depicting a method associated with the event-based authorization system for monitoring events, calibrating policies, and taking necessary actions to shift to the safe state, in accordance with an embodiment of the present disclosure;

FIG. 5 illustrates a process flow depicting a method associated with event-based authentication, in accordance with an embodiment of the present disclosure; and

FIG. 6 illustrates a process flow depicting a method associated with event-based authentication, in accordance with another embodiment of the present disclosure.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### SUMMARY

In an embodiment of the disclosure, a system for event-driven authentication is disclosed. The system comprises at least one processor and a memory operatively associated with the processor. The memory includes machine executable instructions that when executed by the processor cause the processor to monitor, in real time, events associated with authentication requests received from one or more external devices, the events comprising one or more of real-time user interactions, device telemetry, and contextual security events. The processor is further configured to generate an adaptive authentication profile based on at least on behavioural deviations, external device parameters, and the monitored parameters. The processor is further configured to generate a confidence score for the authentication requests by dynamically scoring the authentication requests based on the adaptive authentication profile and taking into account the monitored events. The processor is further configured to dynamically adjust authentication requirements based on the generated confidence score for the authentication request, thereby enabling the system to select reduced authentication requirements or increased authentication requirements.

In an embodiment of the disclosure, a method for event-driven authentication is disclosed. The method comprises monitoring, in real time, events associated with authentication requests received from one or more external devices, the events comprising one or more of real-time user interactions, device telemetry, and contextual security events. The method further comprises generating an adaptive authentication profile based on at least on behavioural deviations, external device parameters, and the monitored parameters. The method further comprises generating a confidence score for the authentication requests by dynamically scoring the authentication requests based on the adaptive authentication profile and taking into account the monitored events. The method further comprises dynamically adjusting authentication requirements based on the generated confidence score for the authentication request, thereby enabling selection of reduced authentication requirements or increased authentication requirements.

In an embodiment of the disclosure, a method for event-based authorization is disclosed. The method comprises monitoring occurrence of one or more events associated with a system. The method further comprises detecting a current context associated with the system. The method further comprises detecting a historical context associated with the system. The method further comprises calibrating one or more policies and taking actions to shift the system to a safe state based on the current context, the historical context, and a plurality of decision inputs.

In an embodiment of the disclosure, a method for event-based authentication is disclosed. The method comprises capturing a sequence of user actions, system events, device interactions, and environmental conditions. The method further comprises generating an authentication signature by analyzing at least one of the sequence of user actions, system events, device interactions, and environmental conditions. The method further comprises constructing a multi-dimensional authentication vector based on one or more of: predefined behavioural patterns, dynamically learned user behaviours, and real-time contextual signals. The method further comprises validating a user's identity based on an authentication score derived from continuous assessment of behavioural coherence, device trust level, and anomaly detection. The method further comprises enabling authentication with or without traditional credentials based on a trust evaluation.

### DETAILED DESCRIPTION OF FIGURES

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

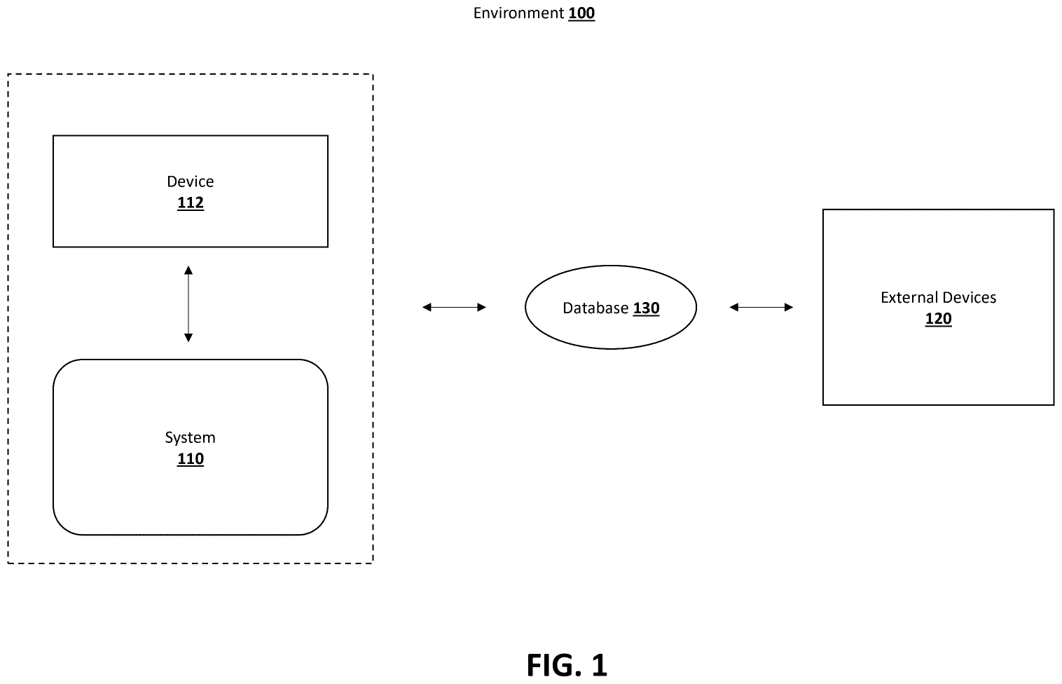

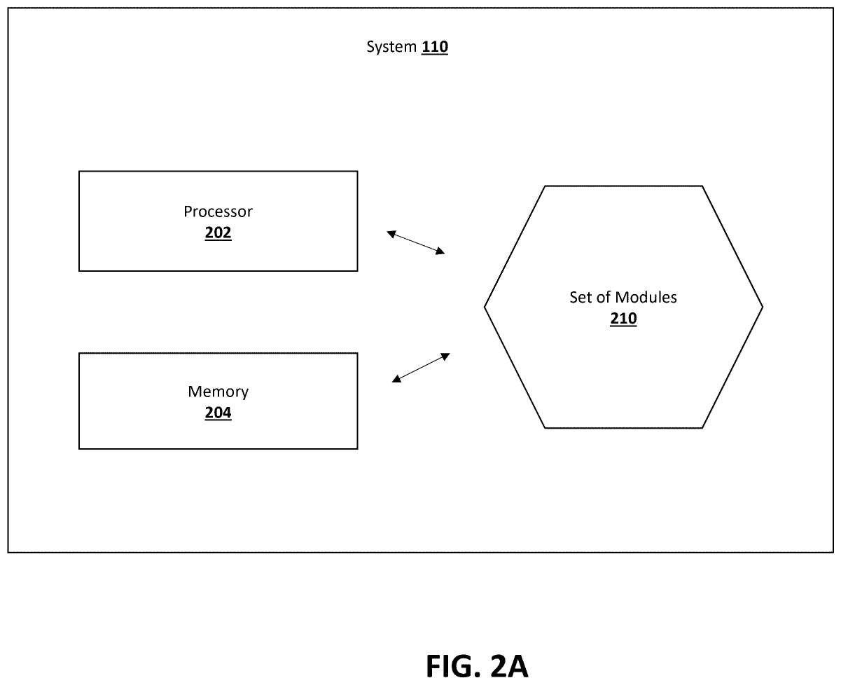

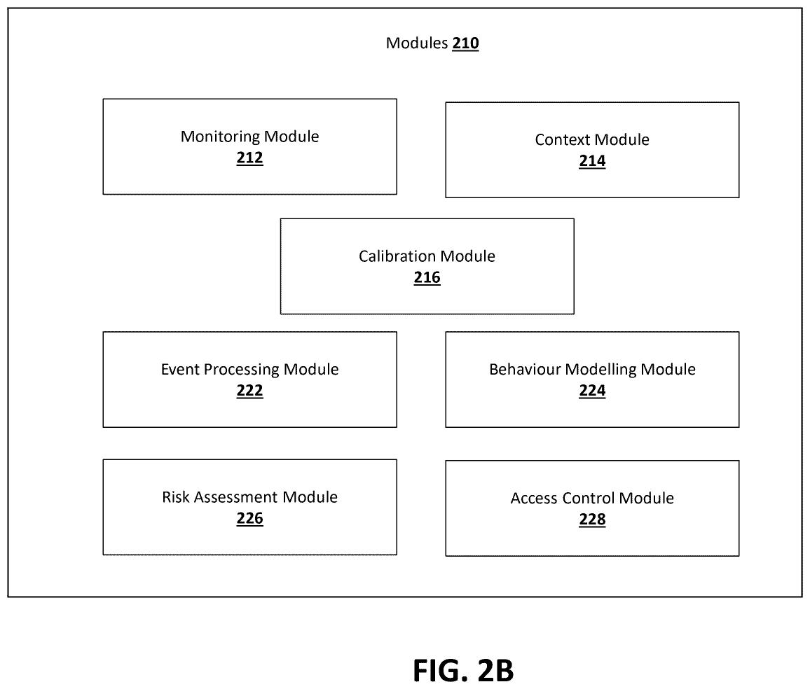

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates a block diagram of an environment 100 comprising a system 110 for monitoring events, calibrating policies, and taking necessary actions to shift to the safe state, according to an embodiment of the present invention. The environment comprises a device 112 in communication with the system 110. In an embodiment, the system 110 may be implemented in conjunction with the device 112. For instance, the system 110 may be integrated within the device 112. In another embodiment, the system 110 may be implemented in a cloud-based server remote from the device 112. In such a scenario, the system 110 may be in communication with the device 112 via a suitable communication network.

The device 112 may comprises a user interface allowing a user to access the system 110. The user may be, for instance, an administrator. The user interface of the device 112 may allow the administrator to manage the system 110. In an exemplary embodiment, the device 112 may include a laptop computer, a desktop computer, a smartphone, and the like. Further, the network connecting the device 112 and the system 110 may include a wireless network or a wired network. For example, the network corresponds to Wi-Fi, cellular networks such as 3G, 4G, 5G, pre-5G, 6G network, or any other wireless communication network.

The environment 100 may further include one or more external devices 120. The device 112, the system 110, and the external devices 120 may form part of an organization. The environment 100 may further include a database 130 configured to store data relevant to the organization. The external devices 120 may include electronic devices that may be used by users of the organization for accessing data stored in the database 130.

FIG. 2A illustrates a block diagram of the system 110 depicted in FIG. 1. The system 110 includes one or more processors 202 (alternatively referred to as a ‘processor 202’) and a memory 204. As a non-limiting example, the one or more processors 202 are a single processing unit or a set of units each including multiple computing units. The one or more processors 202 are implemented as one or more microprocessors, microcomputers, microcontrollers, digital signal processors, central processing units, state machines, logic circuitries, and/or any devices that manipulate signals based on operational instructions (computer-readable instructions) stored in the memory 204. Among other capabilities, the one or more processors 202 are configured to fetch and execute computer-readable instructions and data stored in the memory 204. The one or more processors 202 include one or a plurality of processors. The plurality of processors are further implemented as a general-purpose processor, such as a central processing unit (CPU), an application processor (AP), or the like, a graphics-only processing unit, such as a graphics processing unit (GPU), a visual processing unit (VPU), and/or an AI-dedicated processor such as a neural processing unit (NPU). The plurality of processors control the processing of the input data in accordance with a predefined operating rule or an artificial intelligence (AI) model stored in the memory 204. The predefined operating rule or the AI model is provided through training or learning.

The one or more processors 202 are disposed in communication with one or more input/output (I/O) devices via an Input/Output (I/O) interface. The I/O interface employs communication code-division multiple access (CDMA), high-speed packet access (HSPA+), global system for mobile communications (GSM), long-term evolution (LTE), WiMax, or the like, etc. In another embodiment of the present invention, the I/O interface employs ethernet, industrial wireless Local Area Network (LAN), Process Field Bus (PROFIBUS), Actuator Sensor (AS) Interface, and the like.

In some embodiments, the memory 204 is communicatively coupled to the one or more processors 202. The memory 204 is configured to store instructions executable by the one or more processors 202. In one embodiment, the memory 204 communicates via a bus within the system 110. The memory 204 includes, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory includes a cache or random-access memory (RAM) for the one or more processors 202.

In alternative examples, the memory 204 is separate from the one or more processors 202 such as a cache memory of a processor, the system memory, or other memory. The memory 204 is an external storage device or a database for storing data. The memory 204 is operable to store instructions executable by the one or more processors 202. The functions, acts or tasks illustrated in the figures or described are performed by the programmed processor for executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies include multiprocessing, multitasking, parallel processing, and the like.

The memory 204 may include an operating system for performing one or more tasks of the system 110, as performed by a generic operating system in the communications domain. In one embodiment, the memory 204 is configured to store the information as required by the one or more processors 202 to perform one or more functions for event-based authorisation and dynamic adjustment of policies.

The system 110 further comprises a set of modules 210. The processor 202 may be configured to perform designated functions in conjunction with the memory 204 and the set of modules 210. In some embodiments, the set of modules 210 may be included within the memory 204. In some embodiments, the set of modules 210 may include a set of instructions that may be executed to cause the system 110, in particular, the processor 202, to perform any one or more of the methods disclosed herein. The set of modules 210 in conjunction with the processor 202 may be configured to perform the steps of the present disclosure using the data stored in the memory 204, as discussed throughout this disclosure. In an embodiment, each of the set of modules 210 may be software modules within the memory 204. In an embodiment, each of the set of modules 210 may be hardware units that may be outside the memory 204.

FIG. 2B illustrates a block diagram of the set of modules 210 associated with the system 110 depicted in FIG. 1. The set of modules 210 may comprise a monitoring module 212, a context module 214, a calibration module 216, an event processing module 222, a behaviour modelling module 224, a risk assessment module 226, and an access control module 228. It is to be understood herein that the set of modules 210 may be configured to perform their corresponding functionalities in conjunction with the processor 202. The functionalities of the set of modules 210 are described in detail further below.

In an embodiment, the system 110 is provided in a distributed manner, in that, one or more components and/or functionalities of the system 110 are provided through an electronic device, and one or more components and/or functionalities of the system 110 are be provided through a cloud-based unit, such as, a cloud storage or a cloud-based server. In a non-limiting example, the memory 204 may be provided through the cloud storage and the one or more processors 202 may be integrated with an electronic device (such as the device 112).

Further, the present invention also contemplates a computer-program product that includes instructions or receives and executes instructions responsive to a propagated signal. Further, the instructions may be transmitted or received over the network via a communication port or interface or using a bus (not shown). The communication port or interface may be a part of the one or more processors 202 or may be a separate component. The communication port may be created in software or may be a physical connection in hardware. The communication port may be configured to connect with the network, external media, the display, or any other components in the system 110. The connection with the network may be a physical connection, such as a wired ethernet connection, or may be established wirelessly. Likewise, the additional connections with other components of the system 110 may be physical or may be established wirelessly. The network may alternatively be directly connected to the bus. For the sake of brevity, the architecture, and standard operations of the memory 204 and the one or more processors 202 are not discussed in detail.

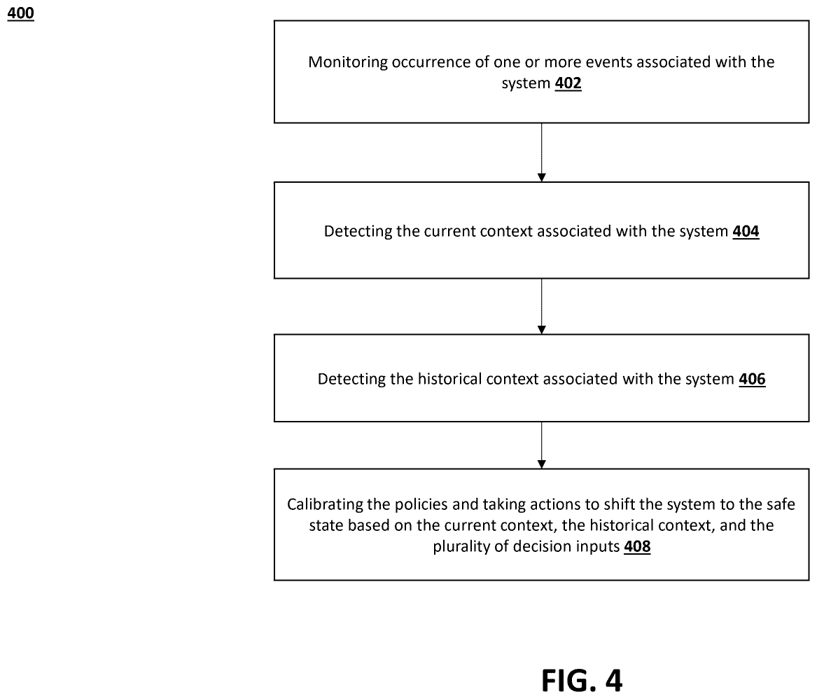

In an embodiment, the computer-program product, having machine-readable instructions stored therein, when executed by one or more processors 202, causes the one or more processors 202 to perform a method as elaborated in subsequent paragraphs at least with reference to FIG. 4.

Further, the present invention also contemplates a non-transitory computer-readable medium encoded with executable instructions. The executable instructions, when executed by one or more processors 202, causes the one or more processors 202 to perform a method as elaborated in subsequent paragraphs at least with reference to FIG. 4. Examples of computer-readable mediums include nonvolatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

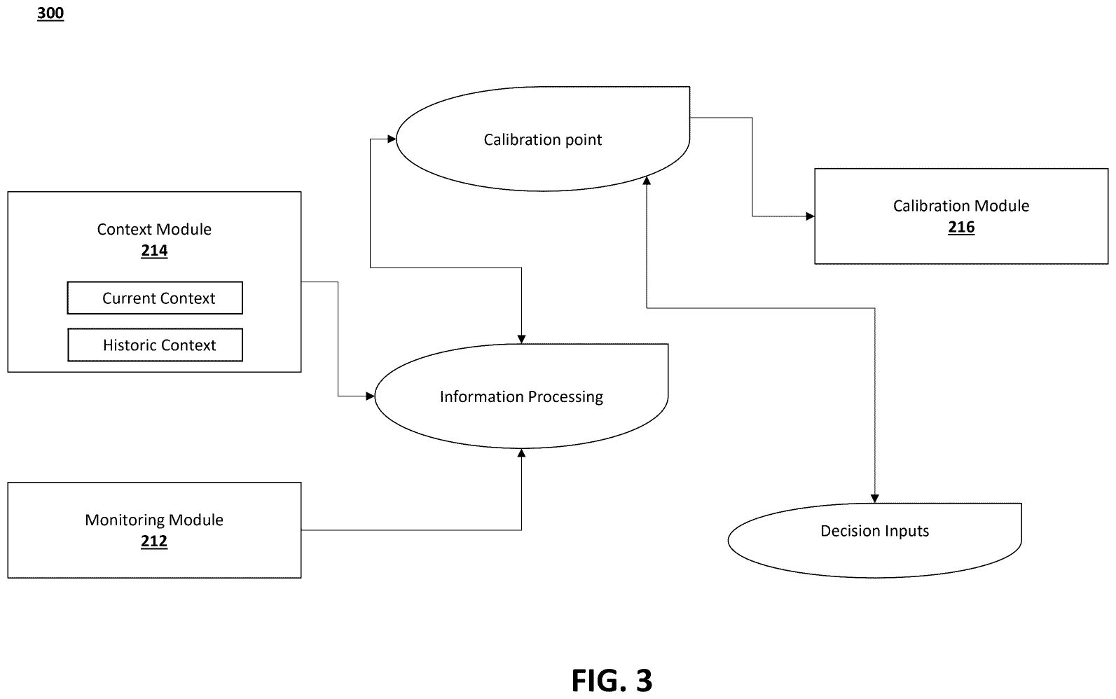

FIG. 3 illustrates a process flow 300 depicting operations among the monitoring module 212, the context module 214, and the calibration module 216 of the system 110.

Referring to FIGS. 1-3, the processor 202 in conjunction with the monitoring module 212 may be configured to monitor occurrence of one or more events associated with the system 110 and detect the occurrence of the one or more events. The term ‘one or more events’ may be referred to as ‘events’ or ‘event’ hereinafter. The details may be explained with respect to an event, however it is appreciated that the details will be equally applicable for multiple events that are detected by the monitoring module 212.

In an embodiment, the event may include an explicit event. The explicit event may be an external event which may be sent from the external devices 120. The external event may relate to trends of the external devices 120 including, but not limited to notifications, alerts, logs, messages, and the like. The explicit event may alternatively be a self-invoked event. The self-invoked event may relate to event generated by the system 110 including, but not limited to, micro-authorisation related event or user-entity behaviour anomalies.

In an embodiment, the event may include an implicit event. The implicit events may be associated with temporal characteristics, such as but not limited to seasonal rules, window-based timeouts, etc.

The processor 202 in conjunction with the monitoring module 212 may be configured to continuously monitor (alternatively referred to as ‘listening’) the event. In an embodiment, the monitoring module 212 may monitor occurrence of the event at pre-defined intervals.

The processor 202 in conjunction with the context module 214 may be configured to determine a current context associated with the system 110.

In an embodiment, the current context may refer to a state of the system 110. The state of the system 110 may be related to multiple parameters such as system utilization, threat level, availability of the system 110, connectivity of the system 110, security state of the system 110, desired state of the system 110, policies associated with the system 110, recent policy and privilege changes associated with the system 110.

In an embodiment, the current context may refer to authorisation parameters such as login attempts, login failures, duration of interaction during authorisation process, confidence thresholds associated with the system 110, etc.

In an embodiment, the current context may refer to behavioural trends over a pre-defined time duration.

In an embodiment, the current context may refer to state of other authorization systems such as authorization system associated with the external devices 120. In an embodiment, the current context may refer to temporal (time-based) context.

Further, the processor 202 in conjunction with the context module 214 may be configured to determine a historical context associated with the system 110.

In an embodiment, the historical context may refer to a plurality of historical characteristics based on data collected during past use of the system 110. The historical characteristics may relate to characteristics of an accessor, such as, identification, group, role, user attributes, etc. The historical characteristics may also relate to session type, session span, session activities, device characteristics, access request parameters, access channel characteristics-type, configuration, location, IP address, etc. Further, the historical characteristics may relate to characteristics of resource groups, classifications, and states.

Furthermore, the historical characteristics may relate to characteristics of policies associated with the system 110. The characteristics of policies may refer to policy definition, policy structure, privilege ranges used for access, etc.

Moreover, the historical characteristics may relate to characteristics of events' interactions and respective system states determined based on durations of no known attack, anomaly logs, notes analysis, etc. The events interactions and respective system states may be metric based or may be assumptive.

In an embodiment, the processor 202 in conjunction with the context module 214 may be configured to determine the current context and the historical context using one or more models. The one or more models may include Artificial Intelligence (AI) models, Machine learning (ML) models, heuristics models, statistical models, and the like.

In an embodiment, the processor 202 in conjunction with the context module 214 may be configured to compare the current context with the historical context using the one or more models. As a non-limiting example, location, device types, time of day, user behaviour, and environmental factors may be analyzed using AI or ML models and compared with the historical context.

Further, the processor 202 in conjunction with a calibration module 216 may be configured to perform policy calibrations and take actions to shift the system 110 to a safe state. The calibration module 216 may take into consideration the current context and the historical context. In addition, the calibration module 216 may take into consideration a plurality of decision inputs in order to determine the policy calibrations. The policy calibration may be performed in real-time by the calibration module 216.

In an embodiment, the plurality of decision inputs may be based on decentralized trust networks of other users and/or participating decision points, on-chain governance mechanisms, and/or decentralized reputation protocols. The decisions regarding the access privileges and policy calibrations can be made through the on-chain governance mechanisms or decentralized reputation protocols.

In an embodiment, the plurality of decision inputs may include desired system state definition. The desired system state may refer to the safe state of the system 110. The desired system state definition may be generic definition or event-linked definition.

In an embodiment, the plurality of decision inputs may include empirical data of least privilege range required for a given request type.

In an embodiment, the plurality of decision inputs may include request impact, requested data volume, classification of resources requested, type of access, etc.

Based on the plurality of decision inputs, the historical context, and the current context, the calibration module 216 may be configured to calibrate the policies and take actions to shift the system 110 to a safe state. In an embodiment, the calibration module may further be configured to detect an optimal path from current state to the desired safe state. In an embodiment, the optimal path may be detected based on one or more of reinforcement learning techniques, game theory techniques, and the like.

In an embodiment, the actions may include access revocation in a complete manner, partial manner, time decaying manner, or dynamically based on behaviour of the user/accessor. In an embodiment, the actions may include access grant in a complete manner, partial manner, time extending manner, or dynamically based on behaviour of the user/accessor. Further, the access or revocation periods may be determined as permanent, temporary, or time-based depending on the behaviour of the user/accessor. Accordingly, the system 110 provides the functionality to instantly revoke access privileges in the event of a security incident or the temporary expand access privileges during peak operational demands.

In an embodiment, calibrating the policies may include time and access-based auto decaying and degradation. Auto-decaying policies systematically diminish access levels or permissions for users whose activity or relevance has waned, employing either a time-based or access-based approach. Further, auto-degrading policies encompass a gradual reduction in access privileges triggered by specific conditions, such as recent access patterns, security incidents, policy violations, or organizational structural changes. These auto-decaying policies find application in scenarios like auditor-like access, where access to a specific data subset is granted for a defined period. After this timeframe, access is automatically revoked, and permission is granted again for a different subset of data. This iterative process enables the accessor to sample data in smaller subsets sequentially, enhancing security and control over information access.

In an embodiment, taking the actions include dynamically adapting to potential threats and unusual activities. The dynamic adjustment may be performed based on real-time biometric authorisation and behavioural analysis. That is, real-time biometric authorisation and behavioural analysis may be integrated with the system for continuous assessment of user behaviour, physiological response, and environmental variables.

In an embodiment, taking the actions include access perimeter and change in resources accessible and respective permissions. In an embodiment, taking the actions include creating isolations to minimize traversable surface or creating one-way pathways to force traversal one certain planned paths.

In an embodiment, the system 110 may take actions based on a probability model. In contrast to binary authorization decisions, access may be granted or revoked based on the probability model. In an embodiment, risk scores associated with the accessors may be calculated by the system 110 using the probability model. The risk scores may be adjusted in real-time based on changing parameters associated with the accessors. The access to the accessors can accordingly be provided based on the determined risk scores. In an embodiment, the risk scores may be updated or reset to further calibrate the policies and shift the system 110 towards the desired (safe) state.

In an embodiment, the system 110 implements micro-authorisation process where accessors continuously undergo micro-authorisations throughout the sessions. Based on real-time risk evaluations, the relevant actions (adjusting access level, dynamically granting least privileges necessary for the current task, etc.) can be performed.

In an embodiment, response of the accessor may be tracked by the system 110 and re-authorisation may be performed at a micro-level or a full-level. Further, based on the response, recalibration of the policies may be undertaken by the system 110.

Referring again to FIG. 2B, the set of modules 210 further comprise the event processing module 222, the behaviour modelling module 224, the risk assessment module 226, and the access control module 228.

The processor 202 in conjunction with the event processing module 222 may be configured to monitor real-time user interactions, device telemetry, and contextual security events. In some embodiments, the event processing module may operate in conjunction with the monitoring module 212 as well, in that, the event processing module 222 may utilize the events being monitored by the monitoring module 212.

As described above, the event processing module 222 monitors user interactions. The user interactions may comprise, but not limiting to, keystroke dynamics, mouse movements, touchscreen gestures, navigation sequences, and the like. As described above, the event processing module 222 monitors device telemetry. The device telemetry may include device identifiers, operating system signals, sensor data (e.g., accelerometer, GPS), and network attributes such as IP address and connection type. As described above, the event processing module 222 monitors contextual security events. The contextual security events may include time of access, geolocation, application usage patterns, network changes, location shifts, failed logins, environmental variables, etc.

The event processing module 222 may be configured to perform pre-processing, normalization, and temporal correlation of the monitored events. In some embodiments, the event processing module 222 may be configured to generate event signals corresponding to the monitored events for authentication evaluation. In some embodiments, the event processing module 222 may continuously monitor the events. This is because the authentication events integrate with zero-trust architecture for verifying user legitimacy even after the initial login. In some embodiments, the authentication may be reinforced using adaptive challenge-response mechanisms that dynamically select authentication factors based on real-time threat perceptions and risk scores.

The processor 202 in conjunction with the behavioural modelling module 224 may be configured to generate an adaptive authentication profile based on historical and real-time data streams. In some embodiments, the behavioural modelling module 224 may operate in conjunction with the context module 214 to utilize the current context being determined by the context module 214. For instance, the context module 214 may determine behavioural trends over a pre-defined time duration, and the behavioural modelling module 224 may generate the adaptive authentication profile based on the determined behavioural trends.

In some embodiments, the behavioural modelling module 224 may further be configured to update the adaptive authentication profile. The behavioural modelling module 224 may analyze historical session data and real-time activity to update the adaptive authentication profile. The authentication profile may thus be a dynamic profile that can be used for evaluating coherence and spotting anomalies.

In some embodiments, the adaptive authentication profile may be associated with authentication signatures. In some embodiments, the authentication signatures may be determined based on a sequence of user actions, system events, device interactions, and environmental conditions. In an embodiment, the sequence of user actions, system events, device interactions, and environmental conditions may be monitored and detected by the event processing module 222. Updating the adaptive authentication profile may comprise continuously updating the authentication signatures. For instance, the authentication signatures may be updated based on federated learning or edge-based AI models in order to enable secure and privacy-preserving adaptation without centralized data storage.

In some embodiments, the behavioural modelling module 224 may be configured to set baseline models corresponding to the adaptive authentication profiles using historical interaction data and device usage patterns. The behavioural modelling module 224 may be configured to incorporate machine learning algorithms that continuously learn from new data streams to detect behavioural anomalies. In some embodiments, the behavioural modelling module 224 support supervised and/or unsupervised learning techniques to take into account evolving user behaviour for updating the adaptive authentication profiles.

In some embodiments, the behavioural modelling module 224 may be configured to generate a multi-dimensional authentication vector based on one or more of the events detected by the monitoring module 212 and/or the event processing module 222. In some embodiments, the events may comprise predefined behavioural patterns, dynamically learned user behaviours, and real-time contextual signals.

The processor 202 in conjunction with the risk assessment module 226 may be configured to dynamically compute a confidence score for each authentication attempt. The risk assessment module 226 evaluates risk by measuring deviation from expected behaviour, assessing device integrity, and checking system security posture (e.g., time, location, environment, etc.). For instance, the risk assessment module 226 may evaluate deviations between current behavioural inputs and established behavioural baselines and incorporate device trust indicators such as device health, device status, firmware integrity, and encryption usage. In some embodiments, in case of detecting behaviour that significantly deviates from thresholds, lockdown or conditional access restrictions can be triggered.

In some embodiments, the risk assessment module 226 may operate in conjunction with the calibration module 216 to utilize the risk scores associated with the accessors. Accordingly, the risk assessment module 226 may determine the confidence score to be a trust score used for determining authentication based on behaviours, device state, and security posture.

In some embodiments, the risk assessment module 226 may be configured to validate an identify of the user associated with authentication attempts. The risk assessment module 226 may be configured to compute an authentication score derived from continuous assessment of behavioural coherence, device trust level, and anomaly detection. In some embodiments, the authentication score may be similar to the confidence score discussed above.

In some embodiments, the authentication score may indicate behavioural patterns associated with the users. The authentication score may be updated dynamically based on changing user behaviour over time. The authentication score may thus be considered as a time-sensitive score that indicates trust on the user based dynamically on the user behaviour over time. For instance, in case the user behaviour deviated from established thresholds, the authentication score may also decay correspondingly over time.

The processor 202 in conjunction with the access control module 228 may be configured to dynamically adjust authentication requirements based on the confidence scores and authentications scores for the authentication attempts. For each authentication request, the access control module 612 may be configured to receive the computed confidence scores or risk scores from the risk assessment module 226 and determine whether to grant, deny, or escalate the authentication request. The access control module 228 may be configured to determine the actions to be taken for the authentication request based on predefined policies and adaptive thresholds.

Based on the risk associated with the authentication attempts, the access control module 228 may thus adjust the requirements in real-time. As an example, for low-risk scenarios, password-less access may be granted in response to the authentication request. As another example, for medium or high-risk scenarios, step-up authentication (e.g., challenge-response, biometric fallback, etc.) may be enforced in response to the authentication request. Accordingly, adjusting the authentication requirements may include dynamically adjusting the authentication requirements between password-less access, biometric fallbacks, one-time behavioural challenges, etc. in real time based on monitored events and based on confidence scores of authentication requests.

The access control module 228 may thus be configured to support seamless authentication workflows when trust levels are high, such as password-less login or biometric confirmation only. In case of high-risk scenarios when anomalies or elevated risks are detected, the access control module 228 may be configured to invoke step-up authentication mechanisms. In some embodiments, progressive authentication may be enforced based on the confidence scores of authentication requests. For instance, progressive authentication may enable access to lower-security zones with minimal authentication, while requiring additional validation for accessing high-security zones.

In some embodiments, the access control module 228 may be configured to allow authentication without traditional credentials, i.e., password-less access as described above. The decision to allow such access may be based on the authentication scores indicating the user behaviour over time. As an example, in case the user behaviour is in line with the thresholds, the access control module 228 may allow authentication for the authentication attempt without traditional credentials. However, in case the user behaviour deviates significantly from the thresholds in future authentication attempts, the access control module 228 may trigger credential-based authentication for such authentication attempts.

Similarly, the authentication may be adapted dynamically by the access control module 228 based on several other parameters. For instance, authentication may be adapted based on proximity-based security policies including geofencing and trusted network heuristics. Further, authentication may be adapted based on real-time anomaly detection identifying inconsistencies in login habits, typing speed, or access patterns. Moreover, authentication may be adapted based on cross-device verification ensuring consistency of authentication signatures across a plurality of devices being used for authentication attempts.

FIG. 4 illustrates an exemplary process flow depicting a method 400 associated with the event-based authorization system 110 for monitoring events, calibrating policies, and taking necessary actions to shift to the safe state. The method 400 may be performed by the system 110, in particular, with the processor 202 in conjunction with the modules 210.

At step 402, the method includes monitoring occurrence of one or more events associated with the system 110.

At step 404, the method includes detecting the current context associated with the system 110.

At step 406, the method includes detecting the historical context associated with the system 110.

At step 408, the method includes calibrating the policies and taking actions to shift the system 110 to the safe state based on the current context, the historical context, and the plurality of decision inputs.

It is to be noted that the details involved in the steps of the method 400 have been detailed with reference to FIGS. 1-3 and have not been repeated herein for the sake of brevity.

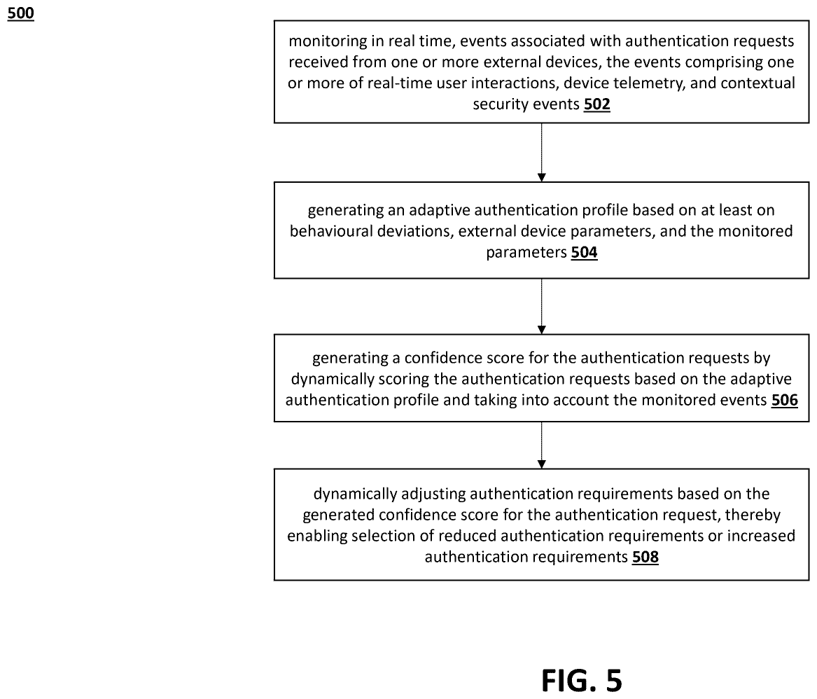

FIG. 5 illustrates another exemplary process flow depicting a method 500 associated with the system 110 for event-driven authentication. The method 500 may be performed by the system 110, in particular, with the processor 202 in conjunction with the modules 210.

At step 502, the method includes monitoring, in real time, events associated with authentication requests received from one or more external devices 120. The events comprise one or more of real-time user interactions, device telemetry, and contextual security events. It is to be noted that the details involved in the step 502 have been detailed with reference to the event processing module 222 and have not been repeated herein for the sake of brevity.

At step 504, the method includes generating an adaptive authentication profile based on at least on behavioural deviations, external device parameters, and the monitored parameters. It is to be noted that the details involved in the step 504 have been detailed with reference to the behaviour modelling module 224 and have not been repeated herein for the sake of brevity.

At step 506, the method includes generating a confidence score for the authentication requests by dynamically scoring the authentication requests based on the adaptive authentication profile and taking into account the monitored events. It is to be noted that the details involved in the step 506 have been detailed with reference to the risk assessment module 226 and have not been repeated herein for the sake of brevity.

At step 508, the method includes dynamically adjusting authentication requirements based on the generated confidence score for the authentication request, thereby enabling the system 110 to select reduced authentication requirements or increased authentication requirements. It is to be noted that the details involved in the step 508 have been detailed with reference to the access control module 228 and have not been repeated herein for the sake of brevity.

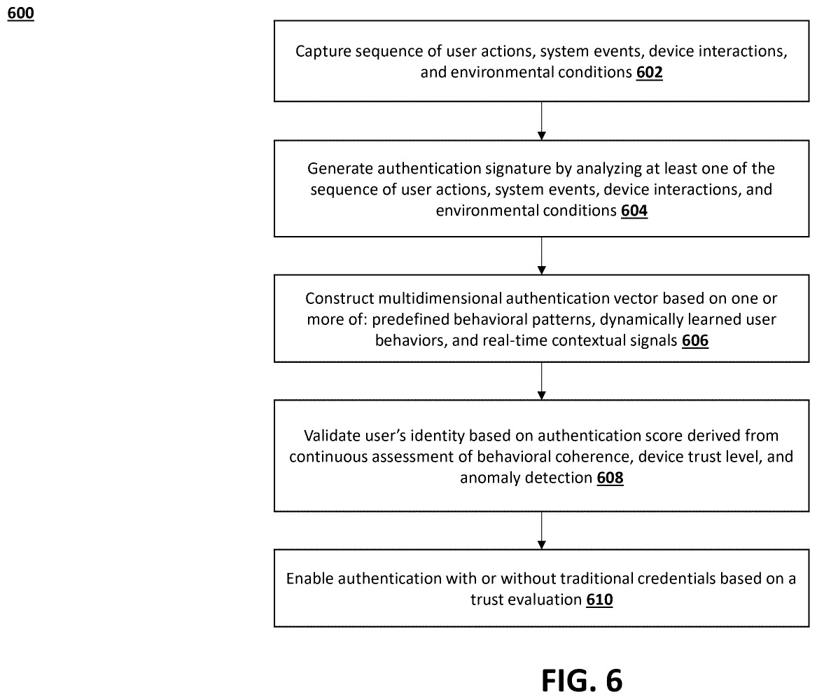

FIG. 6 illustrates another exemplary process flow depicting a method 600 associated with the system 110 for event-driven authentication. The method 600 may be performed by the system 110, in particular, with the processor 202 in conjunction with the modules 210.

At step 602, the method includes capturing a sequence of user actions, system events, device interactions, and environmental conditions.

At step 604, the method includes generating an authentication signature by analyzing at least one of the sequence of user actions, system events, device interactions, and environmental conditions.

At step 606, the method includes constructing a multi-dimensional authentication vector. The construction of the authentication vector may be based on one or more of: predefined behavioural patterns, dynamically learned user behaviours, and real-time contextual signals.

At step 608, the method includes validating a user's identity based on an authentication score derived from continuous assessment of behavioural coherence, device trust level, and anomaly detection.

At step 610, the method includes enabling authentication with or without traditional credentials based on a trust evaluation.

It is to be noted that the details involved in the steps of the method 600 have been detailed with reference to FIGS. 1-2 and have not been repeated herein for the sake of brevity.

Accordingly, an event-driven authentication and adaptive authorisation system and a related method has been described in the present disclosure. The system enables continuous monitoring of security threats. The system further enables continuous monitoring of user behaviours and contextual events. The system dynamically adjusts access control policies and permissions in real-time. Authentication is derived from a combination of predefined or contextually learned user actions, enabling both password-less and hybrid authentication mechanisms. The system continuously assesses risk factors, anomalous behaviours, and evolving security conditions to refine access permissions dynamically.

Thus, an intelligent system is achieved that is resilient against changing parameters and security risks. For instance, the system is resilient against changing user behaviours and user responsibilities within an organization. Since such user behaviour and responsibilities can change over time, the system adapts to such changes and ensures that appropriate privileges are provided to the users based on real-time risk assessments. Thus, the system adapts to changing threat landscape and changing user behaviour. As a result, enhanced security, flexibility, and operational efficiency is achieved by the robust and responsive system that is becoming essential for organizations in today's environment of rapidly evolving cyber threats.

One example where the event-based authorisation system and the related methods may be employed include clinical trial database lock. In such a case, when a clinical trial enters database lock, the system revokes WRITE permissions for all users ensuring data integrity.

Further, the system may be used in various environments for geo-location-based access control, device-based access control, time-based access control, and/or risk-based access control. For instance, the system can tailor a user's resource access based on their current location, fortifying security by preventing unauthorized entry from outside designated areas. The system can also grant or revoke access based on the type of device employed, mitigating risks associated with sensitive data exposure on untrusted devices. Additionally, the system enables access to be limited to predefined time periods, such as business hours, curbing unauthorized entry during off-hours. The system can also dynamically adjust access levels according to a user's risk profile, considering factors like past behaviour or security incidents.

In another example, the system can be used for fraud detection and response functions. For proactive security, the system can automatically curtail access to accounts or resources upon detecting suspicious activity, averting potential fraud. Moreover, the system can facilitate compliance enforcement by dynamically ensuring adherence to regulations or policies based on real-time events, thereby ensuring continuous compliance.

The details in the present disclosure have been described for event-based authorization system and associated methods in order to monitor events, calibrate policies, and take necessary actions to shift to the safe state. It is appreciated that one or more details described in the present disclosure are also applicable for dynamic event-based authentication systems and the associated methods, without departing from the scope of the invention.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

It will be appreciated that the modules, processes, systems, and devices described above can be implemented in hardware, hardware programmed by software, software instruction stored on a non-transitory computer readable medium or a combination of the above. Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

1. A system for event-driven authentication, the system comprising:
at least one processor; and
a memory operatively associated with the processor, the memory, including machine executable instructions that when executed by the processor cause the processor to:
monitor, in real time, events associated with authentication requests received from one or more external devices, the events comprising one or more of real-time user interactions, device telemetry, and contextual security events;
generate an adaptive authentication profile based on at least on behavioural deviations, external device parameters, and the monitored parameters;
generate a confidence score for the authentication requests by dynamically scoring the authentication requests based on the adaptive authentication profile and taking into account the monitored events; and
dynamically adjust authentication requirements based on the generated confidence score for the authentication request, thereby enabling the system to select reduced authentication requirements or increased authentication requirements.

2. The system according to claim 1, wherein to dynamically adjust the authentication requirements, the processor is configured to select reduced authentication requirements in low-risk scenarios based on the confidence score and real-time event monitoring.

3. The system according to claim 1, wherein to dynamically adjust the authentication requirements, the processor is configured to select increased authentication requirements in high-risk scenarios based on the confidence score and real-time event monitoring.

4. The system according to claim 1, wherein to generate the confidence score, the processor is configured to determine deviations from baseline behaviours, and upon determining that the determined deviation is greater than a threshold value, the processor is configured to trigger system lockdown or conditional access restrictions.

5. The system according to claim 1, wherein the processor is configured to dynamically update the adaptive authentication profile based on historical session data and real-time session data.

6. The system according to claim 1, wherein to dynamically score the authentication requests, the processor is configured to continuously monitor the behavioural deviations over a period of time, and decay the authentication score over the period of time based on increased behavioural deviations.

7. The system according to claim 1, wherein the processor is configured to dynamically adjust authentication requirements based on one or more of proximity-based security policies, real-time anomaly detection, and cross-device verification.

8. The system according to claim 1, wherein the adaptive authentication profile is associated with authentication signatures determined based on a sequence of user actions, system events, device interactions, and environmental conditions.

9. The system according to claim 8, wherein the processor is configured to update the authentication signatures based on one or more of federated learning and edge-based Artificial Intelligence (AI) models.

10. A method comprising:
monitoring, in real time, events associated with authentication requests received from one or more external devices, the events comprising one or more of real-time user interactions, device telemetry, and contextual security events;
generating an adaptive authentication profile based on at least on behavioural deviations, external device parameters, and the monitored parameters;
generating a confidence score for the authentication requests by dynamically scoring the authentication requests based on the adaptive authentication profile and taking into account the monitored events; and
dynamically adjusting authentication requirements based on the generated confidence score for the authentication request, thereby enabling selection of reduced authentication requirements or increased authentication requirements.
